(19) United States
(12) Patent Application Publication
(10) Pub. No.: US 2022/0015430 A1
(43) Pub. Date: Jan. 20, 2022

(54) Aerosol Generating Device and System

(71) Applicant: JT International S.A., Geneva (CH)

(72) Inventors: Mark Gill, London (GB); Lubos Brvenik, Krpelany (SK)

(73) Assignee: JT International S.A., Geneva (CH)

(21) Appl. No.: 17/281,501

(22) PCT Filed: Dec. 5, 2019
(86) PCT No.: PCT/EP2019/083762

§ 371 Date: Mar. 30, 2021

(30) Foreign Application Priority Data
Dec. 10, 2018 (EP) 18211375.3

(51) Int. Cl. A24F 40/465; A24F 40/20; A24F 40/485; A24D 1/20; H05B 6/36

(52) U.S. Cl. CPC A24F 40/465; A24F 40/20; H05B 6/36; A24D 1/20; A24F 40/485

(57) ABSTRACT

An aerosol generating device includes a substantially cylindrical induction coil and a heating chamber for receiving an aerosol generating article. The induction coil has a longitudinal axis and generates an electromagnetic field whose magnetic field lines pass through the induction coil in a direction substantially parallel to the longitudinal axis. The heating chamber is arranged so that a longitudinal axis or longitudinal direction of an aerosol generating article received in the heating chamber, in use, is substantially perpendicular to the longitudinal axis of the induction coil. A longitudinal axis of the heating chamber is substantially perpendicular to the longitudinal axis of the induction coil.

### TECHNICAL FIELD

The present disclosure relates generally to an aerosol generating device, and more particularly to an aerosol generating device for generating an aerosol for inhalation by a user. Embodiments of the present disclosure also relate to an arrangement that is suitable for generating an aerosol and to an aerosol generating system.

### TECHNICAL BACKGROUND

Devices which heat, rather than burn, an aerosol generating material to produce an aerosol for inhalation have become popular with consumers in recent years.

Such devices can use one of a number of different approaches to provide heat to the aerosol generating material. One such approach is to provide an aerosol generating device which employs an induction heating system and into which an aerosol generating article, comprising aerosol generating material, can be removably inserted by a user. In such a device, an induction coil is provided with the device and an induction heatable susceptor is provided typically with the aerosol generating article. Electrical energy is supplied to the induction coil when a user activates the device which in turn generates an alternating electromagnetic field. The susceptor couples with the electromagnetic field and generates heat which is transferred, for example by conduction, to the aerosol generating material and an aerosol is generated as the aerosol generating material is heated.

Embodiments of the present disclosure seek to provide optimum heating of the susceptor which is necessary for effective aerosol generation.

### SUMMARY OF THE DISCLOSURE

According to a first aspect of the present disclosure, there is provided an aerosol generating device comprising a substantially cylindrical induction coil and a heating chamber for receiving an aerosol generating article, wherein the induction coil has a longitudinal axis and generates an electromagnetic field (for heating one or more susceptors in the aerosol generating article by inducing eddy current and/or magnetic hysteresis losses in the susceptors) whose magnetic field lines pass through the induction coil in a direction substantially parallel to the longitudinal axis, and wherein the heating chamber is arranged so that a longitudinal axis or longitudinal direction of an aerosol generating article received in the heating chamber is substantially perpendicular to the longitudinal axis of the induction coil.

The induction coil may have any suitable construction, e.g., it may be a helical coil or a spiral coil that is wound with a suitable number of turns about the longitudinal axis of the induction coil. The induction coil typically substantially surrounds the heating chamber. The induction coil may have any suitable cross section such as a circular or elliptical cross section, for example. In the latter case, it may allow a longer aerosol generating article to be accommodated within the induction coil because the longitudinal axis or longitudinal direction of the aerosol generating article is substantially perpendicular to the longitudinal axis of the induction coil when received in the heating chamber and so the aerosol generating article effectively extends across the diameter of the induction coil. The major axis (i.e., the longest diameter) of the elliptical induction coil will normally be orientated to be substantially parallel to a longitudinal axis of the heating chamber.

Providing an aerosol generating device where the aerosol generating article is received in the heating chamber, in use, with its longitudinal axis or longitudinal direction substantially perpendicular to both the longitudinal axis of the induction coil and the direction along which the magnetic field lines pass through the induction coil, allows for the easy manufacture of the aerosol generating article and for good electromagnetic coupling between the electromagnetic field and the one or more susceptors in the aerosol generating article.

The aerosol generating article may comprise a body of aerosol forming material. The aerosol generating device is adapted to heat the aerosol forming material, without burning the aerosol forming material, to volatise at least one component of the aerosol forming material and thereby generate an aerosol for inhalation by a user of the aerosol generating device.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

The aerosol forming material may be any type of solid or semi-solid material. Example types of solid or semi-solid material include powder, granules, pellets, shreds, strands, particles, gel, loose leaves, cut filler, porous material, foam material or sheets. The aerosol forming material may comprise plant derived material and in particular tobacco.

The aerosol forming material may be a strip or a bundle of strips, particularly tobacco strips, extending substantially along the longitudinal axis or longitudinal direction of the aerosol generating article.

The aerosol forming material may comprise an aerosol-former. Examples of aerosol-formers include polyhydric alcohols and mixtures thereof such as glycerine or propylene glycol. Typically, the aerosol forming material may comprise an aerosol-former content of between approximately 5% and approximately 50% on a dry weight basis. In some embodiments, the aerosol forming material may comprise an aerosol-former content of between approximately 10% and approximately 20% on a dry weight basis, and possibly approximately 15% on a dry weight basis.

Upon heating, the aerosol forming material may release volatile compounds. The volatile compounds may include nicotine or flavour compounds such as tobacco flavouring.

Different regions of the body may comprise different types of aerosol forming material, may include different aerosol-formers or have different aerosol-former content, or may release different volatile compounds upon heating.

There is no restriction on the shape and form of the aerosol generating article. In some embodiments, the aerosol generating article may be substantially cylindrical or rod-shaped and as such the heating chamber may be arranged to receive a substantially cylindrical or rod-shaped article. This may be advantageous as, often, vaporisable or aerosolable substances and tobacco products in particular, are packaged and sold in cylindrical form. Another advantage of using a cylindrical aerosol generating article is ease of manufacturing. In particular, it may be possible to make use of manufacturing technology and equipment that is currently used to manufacture other cylindrical tobacco products such as cigarettes, for example. This may make it easy to manufacture aerosol generating articles where the one or more susceptors generally extend along the longitudinal axis of the aerosol generating article. The aerosol generating device of the present disclosure may provide efficient heating of an aerosol generating article that is also easy and cost-effective to manufacture.

The aerosol forming material may be held inside an air permeable material. This may comprise an air permeable material which is electrically insulating and non-magnetic. The material may have a high air permeability to allow air to flow through the material with a resistance to high temperatures. Examples of suitable air permeable materials include cellulose fibres, paper, cotton and silk. The air permeable material may also act as a filter. In one embodiment, the aerosol forming material may be wrapped in paper. The aerosol forming material may also be held inside a material that is not air permeable, but which comprises appropriate perforations or openings to allow air flow, or where the material does not cover the whole of the aerosol forming material. For example, the aerosol forming material might be held within a tube of material that may not be air permeable but whose ends are open to permit air flow through the aerosol forming material. Alternatively, the aerosol generating article may consist of the body of aerosol forming material itself.

The induction coil may be arranged to operate in use with an alternating electromagnetic field having a magnetic flux density of between approximately 20 mT and approximately 2.0 T at the point of highest concentration.

The aerosol generating device may include a power source and circuitry which may be configured to operate at a high frequency. The power source and circuitry may be configured to operate at a frequency of between approximately 80 kHz and 500 kHz, possibly between approximately 150 kHz and 250 kHz, and possibly at approximately 200 kHz. The power source and circuitry could be configured to operate at a higher frequency, for example in the MHz range, depending on the type of inductively heatable susceptor that is used.

The heating chamber may comprise a curved wall and a perpendicular direction of a plane including the curving direction of the curved wall may be substantially perpendicular to the longitudinal axis of the induction coil. Consequently, the perpendicular direction is substantially parallel to the longitudinal axis or longitudinal direction of the aerosol generating article. If the heating chamber is substantially cylindrical, for example, the perpendicular direction will be the longitudinal axis of the heating chamber.

The device may include an opening through which the aerosol generating article may be inserted into the heating chamber. The opening may be positioned between axially spaced electrically conductive tracks or turns of the induction coil. The aerosol generating article may be inserted into the heating chamber along a direction that is parallel with the longitudinal axis of the heating chamber, or along a direction that is perpendicular to the longitudinal axis of the heating chamber, for example, along a radius of the heating chamber if it is substantially cylindrical.

The device may include a cover for accessing the heating chamber, for example from the direction of the longitudinal axis of the induction coil. The cover may be positioned at an opening of the device through which the aerosol generating article may be inserted into the heating chamber. Preferably the cover will not obstruct the aerosol generating article as it is inserted or removed, so that the aerosol generating device has a reliable design and construction. The cover may have a surface defining at least part of the heating chamber, and any reference herein to a surface of a heating chamber should be taken to include a surface of the cover if appropriate. Further, in this case, the opening of the device and the cover may be easily located inside of the induction coil, meaning a relatively large opening and cover may be arranged easily without having to separate the electrically conductive tracks or turns of the induction coil.

The cover may be provided as a door, for example, a hinged door, a sliding door or a detachable or removable door.

The device may include an air inlet which is arranged so that air flows into the heating chamber at a first position in a direction substantially perpendicular to the longitudinal axis of the induction coil. The device may include an air outlet which is arranged so that air flows out of the heating chamber at a second position in a direction substantially perpendicular to the longitudinal axis of the induction coil. Such a construction of the air inlet and air outlet means that air may flow through the aerosol generating article without being obstructed by the wrapper, for example.

The device may be arranged to accommodate aerosol generating articles according to a first type that include an integral filter through which a user may inhale the aerosol released on heating. The aerosol generating device may also be arranged to accommodate aerosol generating articles according to a second type and where the device may further comprise a mouthpiece.

According to a second aspect of the present disclosure, there is provided an aerosol generating system comprising:
an aerosol generating device comprising a substantially cylindrical induction coil, wherein the induction coil has a longitudinal axis and generates an electromagnetic field whose magnetic field lines pass through the induction coil in a direction substantially parallel to the longitudinal axis; and
an aerosol generating article;
wherein a longitudinal axis or longitudinal direction of the aerosol generating article is substantially perpendicular to the longitudinal axis of the induction coil.

The aerosol generating article may be received in a heating chamber of the aerosol generating device, for example.

According to a third aspect of the present disclosure, there is provided an arrangement comprising:
a substantially cylindrical induction coil, wherein the induction coil has a longitudinal axis and generates an electromagnetic field whose magnetic field lines pass through the induction coil in a direction substantially parallel to the longitudinal axis; and
an aerosol generating article;
wherein a longitudinal axis or longitudinal direction of the aerosol generating article is substantially perpendicular to the longitudinal axis of the induction coil.

The induction coil may form part of an aerosol generating device. The aerosol generating article may be received in a heating chamber of the aerosol generating device, for example.

The aerosol generating article may comprise a substantially cylindrical or rod-shaped aerosol generating article. The aerosol generating article may have any suitable cross section, e.g., a circular or elliptical cross section.

The aerosol generating article may comprise an inductively heatable susceptor extending along the longitudinal axis or longitudinal direction thereof. It will therefore be readily understood that the susceptor will also be orientated substantially perpendicular to the longitudinal axis of the induction coil and to the direction in which the magnetic field lines pass through the induction coil, in use, e.g., when the aerosol generating article is received in the heating chamber of the aerosol generating device. The heating chamber will therefore be orientated relative to the induction coil and adapted to receive the aerosol generating article in such a manner that the susceptor is substantially perpendicular to the longitudinal axis of the induction coil.

The inductively heatable susceptor may extend from a first end to a second end of an aerosol generating part of the aerosol generating article or the body of aerosol forming material.

The aerosol generating article may comprise a plurality of inductively heatable susceptors, each susceptor extending along the longitudinal axis or longitudinal direction thereof. Such an aerosol generating article may be easy to manufacture.

Each susceptor may be provided in the form of a sheet or strip, which may give efficient heating. Each susceptor may be formed of any suitable material such as aluminium, for example. Other materials may comprise one or more, but not limited, of iron, nickel, stainless steel and alloys thereof, e.g. Nickel Chromium or Nickel Copper.

Each sheet or strip will typically have two parallel major faces and two end faces. A major face of each sheet or strip may be orientated substantially perpendicular to the direction of the electromagnetic field in use. Typically, both major faces of each sheet or strip may be orientated substantially perpendicular to the direction of the electromagnetic field.

If the aerosol generating article comprises a plurality of inductively heatable susceptors, where each inductively heatable susceptor comprises a sheet or strip of electrically conductive material, the sheets or strips are preferably aligned with each other within a body of aerosol forming material such that the normal to a major face of each sheet or strip is directed in substantially the same direction. In this case, the direction along which each normal is directed is preferably one that is substantially parallel with the direction of the electromagnetic field. In practice, it will be readily understood that, if each sheet or strip has two parallel major faces, the normal to a first major face of each sheet or strip will be directed in a first direction and the normal to a second major face of each sheet or strip will be directed in a second direction, opposite to the first direction, and that both the first and second directions will be substantially parallel with the direction of the electromagnetic field, i.e., the direction through which the magnetic field lines pass through the induction coil.

If the sheets or strips of the aerosol generating article are aligned, it may be possible to ensure that the major face(s) of each sheet or strip are substantially perpendicular to the direction of the electromagnetic field by ensuring the relative orientation between the aerosol generating article and the aerosol generating device, e.g., by limiting how the aerosol generating article may be inserted into and/or received within the heating chamber of the aerosol generating device. In one arrangement, one of the aerosol generating device and the aerosol generating article may include a protrusion and the other one of the aerosol generating device and the aerosol generating article may include a channel, notch or other recess in which the protrusion is received, such that the aerosol generating article is located relative to the aerosol generating device with the maj or face(s) of each sheet or strip orientated substantially perpendicular to the direction of the electromagnetic field. The protrusion may be received in a channel, notch or other recess that extends along a direction that is parallel to the longitudinal axis of the heating chamber of the aerosol generating device, or that extends along a direction that is perpendicular to the longitudinal axis of the heating chamber when the aerosol generating article is received in the heating chamber in the preferred orientation.

In the case of a substantially cylindrical or rod-shaped aerosol generating article, for example, the protrusion may be provided on the outer cylindrical surface of the aerosol generating article and the channel, notch or other recess may be provided on the cylindrical surface of the heating chamber or vice versa. Alternatively, the protrusion may be provided on one of the end surfaces of the aerosol generating article and the channel, notch or other recess may be provided on a surface of the heating chamber that faces the end surface of the article or vice versa.

The protrusion may be slidably received in the channel, notch or other recess, i.e., in some embodiments the protrusion may slide along the channel, notch or other recess as the aerosol generating article is inserted into and removed from the heating chamber. In one arrangement, where the aerosol generating article is inserted into the heating chamber in a direction that is parallel to the longitudinal axis of the heating chamber, the channel can have an axially-extending part and a circumferentially-extending part meaning that the aerosol generating article is first inserted into the heating chamber in an axial direction and is then partially rotated such that the protrusion is received in the circumferentially-extending part of the channel. When the protrusion is received in the circumferentially-extending part of the channel, the aerosol generating article, and in particular the aligned susceptors, would adopt the preferred orientation relative to the electromagnetic field. Such “slide and twist” engagement can help to retain the aerosol generating article within the heating chamber as well as ensuring proper positioning for improved electromagnetic coupling between the electromagnetic field and the susceptors.

In another arrangement, the aerosol generating article and the aerosol generating device (for example, the heating chamber) may have a complementary profile or shape such that the aerosol generating article is located relative to the aerosol generating device in a preferred orientation with the major face(s) of each sheet or strip substantially perpendicular to the direction of the electromagnetic field. For example, the aerosol generating article may have an elliptical cross section and the heating chamber of the aerosol generating device may have a complementary elliptical cross section and be arranged relative to the induction coil. Alternatively, the aerosol generating article may have any other suitable cross section and the heating chamber may have a complementary cross section such that the aerosol generating article may only be inserted into and/or received within the heating chamber in the preferred orientation where the major face(s) of each sheet or strip are substantially perpendicular to the direction of the electromagnetic field, for efficient coupling therebetween.

### BRIEF DESCRIPTION OF THE DRAWINGS

FIG. 1 is diagrammatic view of a first example of an aerosol generating device;

FIGS. 2a and 2b are diagrammatic views of a first example of a cylindrical aerosol generating article with a circular cross section, where FIG. 2b is a cross section along line A-A of FIG. 2a;

FIG. 3 is a diagrammatic view of the first example of the aerosol generating device shown in FIG. 1 with the first example of the cylindrical aerosol generating article of FIGS. 2a and 2b positioned in the heating chamber;

FIG. 4 is a diagrammatic view of a second example of an aerosol generating device;

FIG. 5 is a diagrammatic view of the second example of the aerosol generating device shown in FIG. 4 with the cylindrical aerosol generating article of FIGS. 2a and 2b positioned in the heating chamber;

FIGS. 6a and 6b are diagrammatic views of a second example of a cylindrical aerosol generating article with a circular cross section, where FIG. 6b is a cross section along line B-B of FIG. 6a;

FIG. 7 is a diagrammatic view of the second example of the cylindrical aerosol generating article with an optional protrusion for ensuring a preferred orientation between the aerosol generating article and the electromagnetic field;

FIG. 8 is a diagrammatic view of a third example of a cylindrical aerosol generating article with an elliptical cross section;

FIG. 9 is a diagrammatic view of a fourth example of a cylindrical aerosol generating article with a D-shaped cross section;

FIG. 10 is a diagrammatic view of a third example of an aerosol generating device;

FIG. 11 is an enlarged diagrammatic view of a rod-shaped aerosol generating article; and

FIG. 12 is a diagrammatic view of the third example of the aerosol generating device shown in FIG. 10 with the rod-shaped aerosol generating article of FIG. 11 positioned in the heating chamber.

### DETAILED DESCRIPTION OF EMBODIMENTS

Embodiments of the present disclosure will now be described by way of example only and with reference to the accompanying drawings.

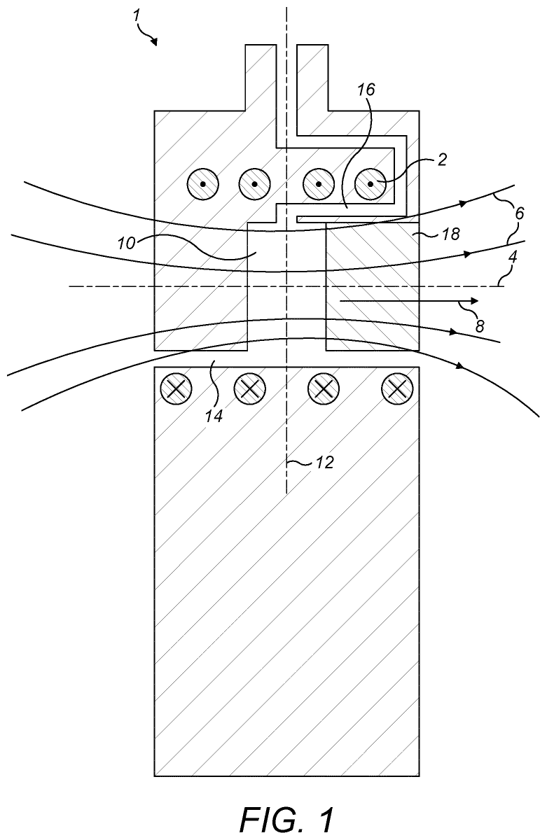

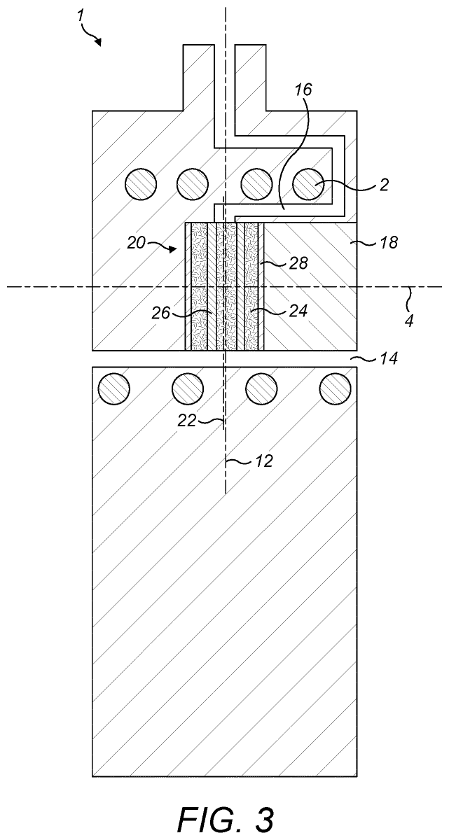

Referring to FIGS. 1 and 3, there is shown diagrammatically an aerosol generating device 1 according to a first embodiment of the disclosure.

The aerosol generating device 1 comprises a helical induction coil 2 with a plurality of turns. In other embodiments, the induction coil can have a different construction, e.g., a spiral construction. The induction coil 2 has a longitudinal axis 4.

The induction coil 2 generates an electromagnetic field in use. As shown in FIG. 1, the magnetic field lines 6 of the electromagnetic field pass through the inside of the induction coil 2 in a direction that is substantially parallel to the longitudinal axis 4. The direction of the electromagnetic field will depend on the direction of current flow through the induction coil 2, i.e., according to the “right-hand grip rule”. In FIG. 1, the dots in the upper turns of the induction coil 2 indicate that the current is flowing out of the plane of the paper and the crosses in the lower turns of the induction coil indicate that the current is flowing into the plane of the paper. In this case, the direction of the electromagnetic field is from left to right as indicated by the arrow 8. But it will be understood that the current flowing though the induction coil 2 is an alternating current, which means that, at a subsequent point in time, the current will flow in the opposite direction. In this case, the direction of the electromagnetic field will be from right to left, i.e., in a direction opposite to that indicated by the arrow 8.

The aerosol generating device 1 comprises a substantially cylindrical heating chamber 10 with a circular cross section. The heating chamber 10 has a longitudinal axis 12 that is substantially perpendicular to the longitudinal axis 4 of the induction coil 2 and to the direction of the electromagnetic field.

The induction coil 2 substantially surrounds the heating chamber 10.

The aerosol generating device 1 comprises an air inlet 14 which is arranged so that air flows into the heating chamber 10 at a first position in a direction substantially perpendicular to the longitudinal axis 4 of the induction coil 2. The aerosol generating device 2 also comprises an air outlet 16 which is arranged so that air flows out of the heating chamber 10 at a second position in a direction substantially perpendicular to the longitudinal axis 4 of the induction coil 2.

The aerosol generating device 1 comprises a cover 18 which is located in an opening and which can be moved (e.g., pivoted, slid or detached) to allow an aerosol generating article to be inserted into the heating chamber 10 through the opening along a radial direction of the heating chamber.

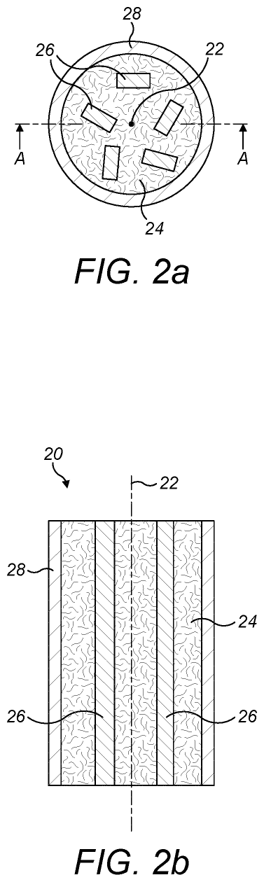

Referring to FIGS. 2a and 2b, there is shown diagrammatically a first example of an aerosol generating article 20 according to an embodiment of the disclosure. The aerosol generating article 20 is substantially cylindrical, with a circular cross section, and has a longitudinal axis 22. The aerosol generating article 20 is shaped and sized to be received within the heating chamber 10 of the aerosol generating device 1. The aerosol generating article 20 comprises a body of aerosol forming material 24 and a plurality of susceptors 26, which are formed as aluminium strips that extend along the longitudinal axis 22 of the aerosol generating article as shown. The aerosol forming material 24 releases volatile compounds upon heating. The volatile compounds may include nicotine or flavour compounds such as tobacco flavouring. The aerosol forming material 24 is held inside a tube or wrapper 28 of air impermeable material such as paper, for example. The aerosol forming material 24 may be a tobacco and may be a bundle of strips, in particular tobacco strips, extending along the longitudinal axis 22. The construction of the air inlet 14 and air outlet 16 means that air may flow through the aerosol generating article 1 without being obstructed by the wrapper, for example.

FIG. 3 shows the first example of the aerosol generating article 20 received in the heating chamber 10 of the aerosol generating device 1. The longitudinal axis 22 of the aerosol generating article 20 is substantially parallel to the longitudinal axis 12 of the heating chamber 10. This means that the longitudinal axis 22 of the aerosol generating article 20 is substantially perpendicular to the longitudinal axis 4 of the induction coil 2 and to the direction of the electromagnetic field that is generated by the induction coil 2 in use. The plurality of susceptors 26 also extend substantially perpendicular to the longitudinal axis 4 of the induction coil 2 and to the direction of the electromagnetic field, which provides improved electromagnetic coupling between the electromagnetic field and the susceptors for more efficient heating.

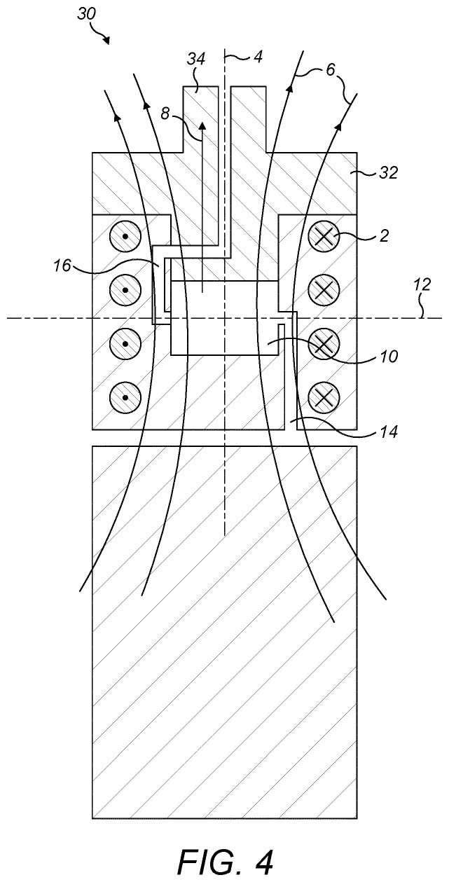

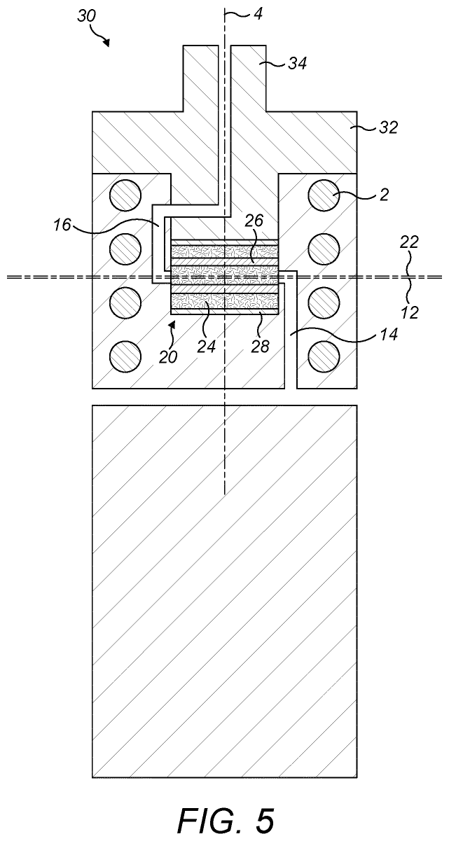

Referring to FIGS. 4 and 5, there is shown diagrammatically an aerosol generating device 30 according to a second embodiment of the disclosure. The aerosol generating device 30 is similar to the aerosol generating device 1 shown in FIGS. 1 and 3 and like parts have been given the same reference sign. In the first embodiment of the aerosol generating device 1 shown in FIGS. 1 and 3, the longitudinal axis 4 of the helical induction coil 2 is substantially perpendicular to the longitudinal axis of the aerosol generating device 1 and the longitudinal axis 12 of the heating chamber 10 is substantially parallel to the longitudinal axis of the aerosol generating device. In the second embodiment, the longitudinal axis 4 of the helical induction coil 2 is substantially parallel to the longitudinal axis of the aerosol generating device 30 and the longitudinal axis 12 of the heating chamber 10 is substantially perpendicular to the longitudinal axis of the aerosol generating device. However, the relative orientation of the heating chamber 10 with respect to the induction coil 2 is the same as described previously.

The aerosol generating device 30 comprises a cover 32 which is located in an opening and which can be moved to allow an aerosol generating article to be inserted into the heating chamber 10 through the opening along a radial direction of the heating chamber. The cover 32 forms part of a mouthpiece 34 connected to the air outlet 16 through which a user may inhale the aerosol released on heating.

FIG. 5 shows the first example of the aerosol generating article 20 of FIGS. 2a and 2b received in the heating chamber 10 of the aerosol generating device 30. The longitudinal axis 22 of the aerosol generating article 20 is substantially parallel to the longitudinal axis 12 of the heating chamber 10. This means that the longitudinal axis 22 of the aerosol generating article 20 is substantially perpendicular to the longitudinal axis 4 of the induction coil 2 and to the direction of the electromagnetic field that is generated by the induction coil in use. The plurality of susceptors 26 also extend substantially perpendicular to the longitudinal axis 4 of the induction coil 2 and to the direction of the electromagnetic field, which provides improved electromagnetic coupling between the electromagnetic field and the susceptors for more efficient heating.

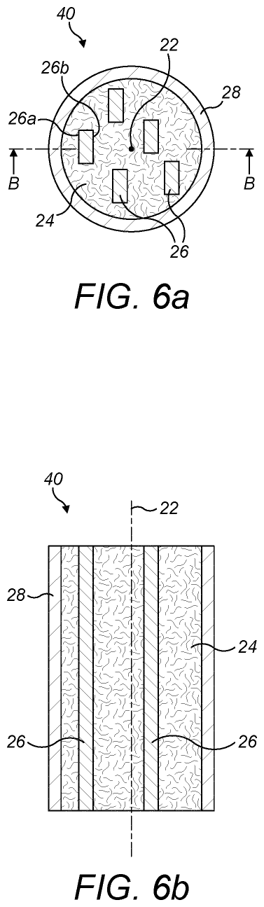

Referring to FIGS. 6a and 6b, there is shown diagrammatically a second example of an aerosol generating article 40 according to an embodiment of the disclosure. The aerosol generating article 40 is similar to the aerosol generating article 20 shown in FIGS. 2a and 2b and like parts have been given the same reference sign. The aerosol generating article 40 is substantially cylindrical, has a circular cross section, and has a longitudinal axis 22. The aerosol generating article 20 comprises a body of aerosol forming material 24 and a plurality of susceptors 26, which are formed as aluminium strips that extend along the longitudinal axis 22 of the aerosol generating article as shown. The aerosol forming material 24 releases volatile compounds upon heating. The volatile compounds may include nicotine or flavour compounds such as tobacco flavouring. The aerosol forming material 24 is held inside a tube or wrapper 28 of air impermeable material such as paper, for example. In the aerosol generating article 20 shown in FIGS. 2a and 2b, the susceptors 26 are not positioned within the body of aerosol forming material 24 in any particular orientation or alignment relative to each other apart from extending substantially along the longitudinal axis 22. However, in the aerosol generating article 40 shown in FIGS. 6a and 6b, the susceptors 26 are aligned with each other. In particular, each susceptor 26 includes a first major face 26a, a second major face 26b, and two end faces. The susceptors 26 are positioned within the body of aerosol forming material 24 such that the normal to the first major face 26a of each susceptor 26 is directed in substantially the same direction (i.e., a first direction) and the normal to the second major face 26b of each susceptor is directed in substantially the same direction (i.e., a second direction that is opposite to the first direction). Preferably, when the aerosol generating article 40 is received in the heating chamber 10 of the aerosol generating device, the first and second directions are substantially parallel to the direction of the electromagnetic field. Put another way, the susceptors 26 are aligned such that they extend substantially perpendicular to the longitudinal axis of the induction coil and that the major faces 26a, 26b of each susceptor are preferably substantially perpendicular to the direction of the electromagnetic field, which provides improved electromagnetic coupling between the electromagnetic field and the susceptors for more efficient heating.

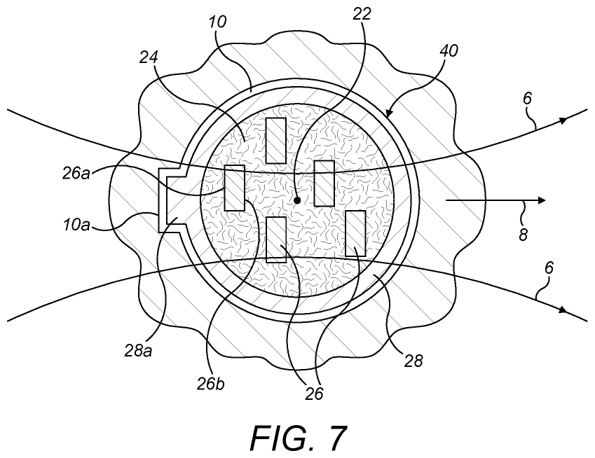

Assuming that the alignment of the susceptors 26 within the aerosol generating article 40 and the direction of the electromagnetic field relative to the heating chamber 10 of the aerosol generating device 40 are both known, it is possible to ensure the preferred orientation between the aligned susceptors 26 and the electromagnetic field by fixing or constraining the orientation between the aerosol generating article 40 and the heating chamber 10. Referring to FIG. 7, the aerosol generating article 40 may be provided with a protrusion 28a on its cylindrical outer surface (i.e., as defined by the tube or wrapper 28) which is received in a channel or recess l0a in the surface of the heating chamber 10. FIG. 7 shows how the major faces 26a, 26b of each susceptor 26 are orientated substantially perpendicular to the direction of the electromagnetic field indicated by arrow 8 for this particular direction of current flow through the induction coil. The fact that the protrusion 28a is received in the channel or recess l0a means that the aerosol generating article 40 can only be received in the heating chamber 10 in this preferred orientation. It also prevents relative rotation between the aerosol generating article 40 and the aerosol generating device. In an alternative embodiment, the aerosol generating article may be provided with a channel, notch or other recess in its outer surface and the protrusion may be formed on the surface of the heating chamber, for example.

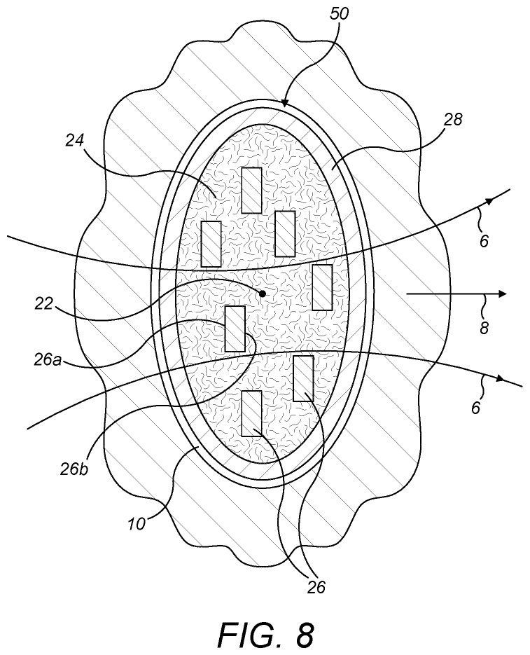

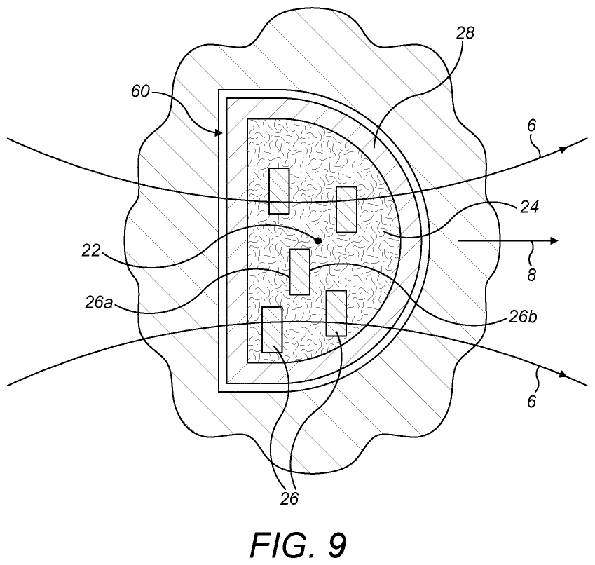

Other means of ensuring the preferred orientation between the aligned susceptors and the electromagnetic field are possible. For example, the aerosol generating article may have a particular profile or shape and the heating chamber of the aerosol generating device may have a complementary profile or shape such that the aerosol generating article may only be received within the heating chamber with the preferred orientation. Referring to FIG. 8, there is shown diagrammatically a third example of an aerosol generating article 50 according to an embodiment of the disclosure. Referring to FIG. 9, there is shown diagrammatically a fourth example of an aerosol generating article 60 according to an embodiment of the disclosure. The aerosol generating articles 50, 60 are similar to the aerosol generating article 40 shown in FIGS. 6a and 6b and like parts have been given the same reference sign. The aerosol generating articles 50, 60 are substantially cylindrical and have a longitudinal axis 22. The aerosol generating articles 50, 60 comprise a body of aerosol forming material 24 and a plurality of susceptors 26, which are formed as aluminium strips that extend along the longitudinal axis 22 of the aerosol generating article as shown. The aerosol forming material 24 releases volatile compounds upon heating. The volatile compounds may include nicotine or flavour compounds such as tobacco flavouring. The aerosol forming material 24 is held inside a tube or wrapper 28 of air impermeable material such as paper, for example. Each susceptor 26 is positioned within the body of aerosol forming material 24 such that the normal to the first major face 26a of each susceptor 26 is directed in substantially the same direction (i.e., a first direction) and the normal to the second major face 26b of each susceptor is directed in substantially the same direction (i.e., a second direction that is opposite to the first direction). The aerosol generating article 50 has an elliptical cross section and the heating chamber 10 of the aerosol generating device has a complementary elliptical cross section such that the aerosol generating article 50 can only be received in the heating chamber 10 in the preferred orientation where the first and second directions are substantially parallel to the direction of the electromagnetic field. The aerosol generating article 60 has a D-shaped cross section with a curved surface and a flat surface and the heating chamber 10 of the aerosol generating device has a complementary D-shaped cross section such that the aerosol generating article 60 can only be received in the heating chamber 10 in the preferred orientation where the first and second directions are substantially parallel to the direction of the electromagnetic field. In both cases, the susceptors 26 are aligned such that the major faces 26a, 26b of each susceptor are substantially perpendicular to the direction of the electromagnetic field, which provides improved electromagnetic coupling between the electromagnetic field and the susceptors for more efficient heating.

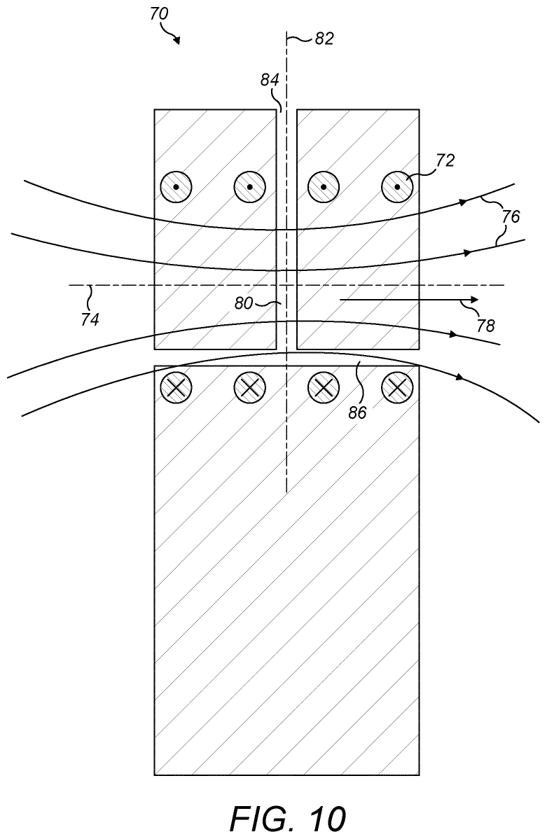

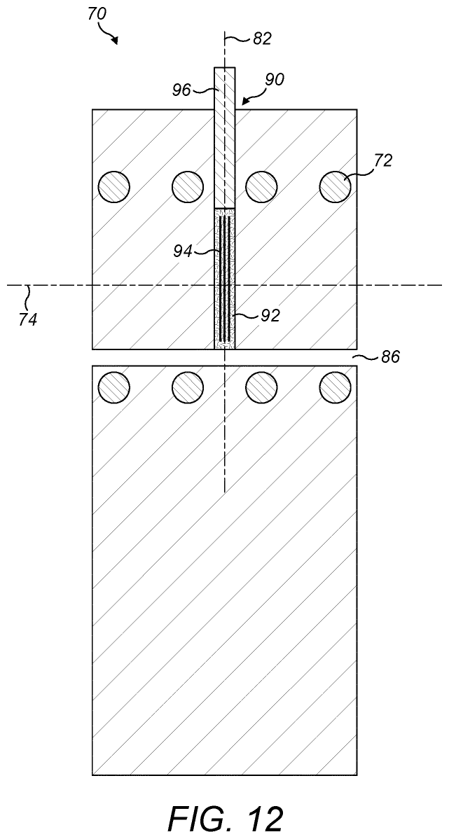

Referring to FIGS. 10 and 12, there is shown diagrammatically an aerosol generating device 70 according to a third embodiment of the disclosure.

The aerosol generating device 70 comprises a helical induction coil 72 with a plurality of turns. In other embodiments, the induction coil can have a different construction, e.g., a spiral construction. The induction coil 72 has a longitudinal axis 74 and generates an electromagnetic field in use. As shown in FIG. 10, the magnetic field lines 76 of the electromagnetic field pass through the inside of the induction coil 72 in a direction that is substantially parallel to the longitudinal axis 74. The direction of the electromagnetic field will depend on the direction of current flow through the induction coil 72. In FIG. 10, the dots in the upper turns of the induction coil 72 indicate that the current is flowing out of the plane of the paper and the crosses in the lower turns of the induction coil indicate that the current is flowing into the plane of the paper. In this case, the direction of the electromagnetic field is from left to right as indicated by the arrow 78. But it will be understood that the current flowing though the induction coil 72 is an alternating current, which means that, at a subsequent point in time, the current will flow in the opposite direction. In this case, the direction of the electromagnetic field will be from right to left, i.e., in a direction opposite to that indicated by the arrow 78.

The aerosol generating device 70 comprises a substantially cylindrical heating chamber 80. The heating chamber 80 has a longitudinal axis 82 that is substantially at right angles to the longitudinal axis 74 of the induction coil 72 and to the direction of the electromagnetic field.

The induction coil 72 substantially surrounds the heating chamber 80.

The aerosol generating device 70 includes an opening 84 through which the aerosol generating article may be inserted into the heating chamber 80. The opening 84 may be positioned between axially spaced electrically conductive turns of the induction coil 72 as shown in FIG. 10 such that the aerosol generating article is inserted into the heating chamber 80 along an axial direction of the heating chamber.

The aerosol generating device 70 comprises an air inlet 86 which is arranged so that air flows into the heating chamber 80 at a first position in a direction substantially perpendicular to the longitudinal axis 74 of the induction coil 72.

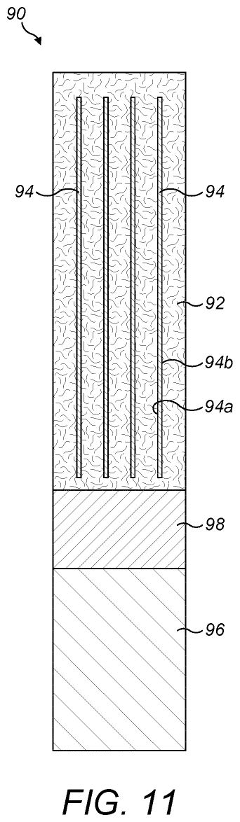

Referring to FIG. 11, there is shown diagrammatically a fifth example of an aerosol generating article 90 according to an embodiment of the disclosure. The aerosol generating article 90 is a rod-shape. The aerosol generating article 90 comprises a body of aerosol forming material 92 and a plurality of susceptors 94, which are formed as aluminium strips that extend along the longitudinal direction of the aerosol generating article 90 as shown. The aerosol forming material 92 releases volatile compounds upon heating. The volatile compounds may include nicotine or flavour compounds such as tobacco flavouring. The aerosol generating article 90 also includes a filter 96 and a spacer 98, which may be formed as a hollow tube and may reduce the vapour temperature.

FIG. 12 shows the aerosol generating article 90 received in the heating chamber 80 of the aerosol generating device 70. The longitudinal direction of the aerosol generating article 90 is substantially parallel to the longitudinal axis 82 of the heating chamber 80. This means that the longitudinal direction of the rod-shaped aerosol generating article 90 is substantially perpendicular to the longitudinal axis 74 of the induction coil 72 and to the direction of the electromagnetic field that is generated by the induction coil in use. The plurality of susceptors 94 also extend substantially perpendicular to the longitudinal axis 74 of the induction coil 72 and to the direction of the electromagnetic field which provides improved electromagnetic coupling between the electromagnetic field and the susceptors and more efficient heating.

In the aerosol generating article 90 shown in FIG. 11, each susceptor 94 includes a first major face 94a, a second major face 94b, and two end faces. Each susceptor 94 is positioned within the body of aerosol forming material 92 such that the normal to the first major face 94a of each susceptor 94 is directed in substantially the same direction (i.e., a first direction) and the normal to the second major face 94b of each susceptor is directed in substantially the same direction (i.e., a second direction that is opposite to the first direction). Preferably, when the aerosol generating article 90 is received in the heating chamber 80 of the aerosol generating device, the first and second directions are substantially parallel to the direction of the electromagnetic field. Put another way, the susceptors 94 are aligned such that the major faces 94a, 94b of each susceptor are preferably substantially perpendicular to the direction of the electromagnetic field, which provides improved electromagnetic coupling between the electromagnetic field and the susceptors for more efficient heating. The preferred orientation between the aligned susceptors and the electromagnetic field may be ensured by providing the aerosol generating article and the aerosol generating device with a protrusion and channel, notch or other recess, or with a complementary profile or shape etc. as described above.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. An aerosol generating device comprising a substantially cylindrical induction coil and a heating chamber for receiving an aerosol generating article, wherein the induction coil has a longitudinal axis and generates an electromagnetic field whose magnetic field lines pass through the induction coil in a direction substantially parallel to the longitudinal axis, and wherein the heating chamber is arranged so that a longitudinal axis or longitudinal direction of an aerosol generating article received in the heating chamber is substantially perpendicular to the longitudinal axis of the induction coil.

2. The aerosol generating device according to claim 1, wherein the heating chamber comprises a curved wall, and wherein a perpendicular direction of a plane including the curving direction of the curved wall is substantially perpendicular to the longitudinal axis of the induction coil.

3. The aerosol generating device according to claim 1, wherein the device includes an opening through which the aerosol generating article can be inserted into the heating chamber and the opening is positioned between axially spaced electrically conductive tracks of the induction coil.

4. The aerosol generating device according to claim 1, wherein the device includes a cover for accessing the heating chamber from the direction of the longitudinal axis of the induction coil.

5. The aerosol generating device according to claim 1, wherein the device includes an air inlet which is arranged so that air flows into the heating chamber at a first position in a direction substantially perpendicular to the longitudinal axis of the induction coil.

6. The aerosol generating device according to claim 1, wherein the device includes an air outlet which is arranged so that air flows out of the heating chamber at a second position in a direction substantially perpendicular to the longitudinal axis of the induction coil.

7. The aerosol generating device according to claim 1, wherein the heating chamber is substantially cylindrical.

8. The aerosol generating device according to claim 1, wherein the induction coil has an elliptical cross section.

9. An aerosol generating system comprising:
an aerosol generating device comprising a substantially cylindrical induction coil, wherein the induction coil has a longitudinal axis and generates an electromagnetic field whose magnetic field lines pass through the induction coil in a direction substantially parallel to the longitudinal axis; and
an aerosol generating article;
wherein a longitudinal axis or longitudinal direction of the aerosol generating article is substantially perpendicular to the longitudinal axis of the induction coil.

10. The aerosol generating system according to claim 9, wherein the aerosol generating article comprises a substantially cylindrical or rod-shaped aerosol generating article including an inductively heatable susceptor extending along the longitudinal axis or longitudinal direction thereof.

11. The aerosol generating system according to claim 10, wherein the inductively heatable susceptor extends from a first end to a second end of an aerosol generating part of the aerosol generating article.

12. The aerosol generating system according to claim 10, wherein the inductively heatable susceptor comprises a strip of electrically conductive material, and wherein a major face of the strip is substantially perpendicular to the direction of the electromagnetic field.

13. The aerosol generating system according to claim 12, wherein one of the aerosol generating device and the aerosol generating article includes a protrusion and the other one of the aerosol generating device and the aerosol generating article includes a channel in which the protrusion is received, such that the aerosol generating article is orientated relative to the aerosol generating device with the major face of the strip substantially perpendicular to the direction of the electromagnetic field.

14. The aerosol generating system according to claim 12, wherein the aerosol generating device and the aerosol generating article have a complementary profile or shape such that the aerosol generating article is orientated relative to the aerosol generating device with the major face of the strip substantially perpendicular to the direction of the electromagnetic field.

15. The aerosol generating system according to claim 14, wherein the aerosol generating device comprises a heating chamber in which the aerosol generating article is received, and wherein the aerosol generating article has an elliptical cross section and the heating chamber has a complementary elliptical cross section.

16. The aerosol generating system according to claim 10, wherein the aerosol generating article comprises a plurality of inductively heatable susceptors extending along the longitudinal axis or longitudinal direction thereof, wherein each inductively heatable susceptor comprises a strip of electrically conductive material, and wherein the strips are aligned such that the normal to a major face of each strip is directed in substantially the same direction.

17. An arrangement comprising:
a substantially cylindrical induction coil, wherein the induction coil has a longitudinal axis and generates an electromagnetic field whose magnetic field lines pass through the induction coil in a direction substantially parallel to the longitudinal axis; and
an aerosol generating article;
wherein a longitudinal axis or longitudinal direction of the aerosol generating article is substantially perpendicular to the longitudinal axis of the induction coil.

18. The arrangement according to claim 17, wherein the aerosol generating article comprises a substantially cylindrical or rod-shaped aerosol generating article including an inductively heatable susceptor extending along the longitudinal axis or longitudinal direction thereof.
